(19) United States
(12) Patent Application Publication
(10) Pub. No.: US 2015/0338657 A1
(43) Pub. Date: Nov. 26, 2015

(54) DISPLAY DEVICE

(71) Applicant: KABUSHIKI KAISHA TOSHIBA, Minato-ku (JP)

(72) Inventors: Aira Hotta, Kawasaki (JP); Tomoya Tsuruyama, Kawasaki (JP); Shimpei Sawada, Kawasaki (JP); Yoshiyuki Kokojima, Yokohama (JP); Akihisa Moriya, Kawasaki (JP); Masahiro Baba, Yokohama (JP)

(73) Assignee: KABUSHIKI KAISHA TOSHIBA, Minato-ku (JP)

(21) Appl. No.: 14/704,643

(22) Filed: May 5, 2015

(30) Foreign Application Priority Data
May 21, 2014 (JP) 2014-105613

(51) Int. Cl. G02B 27/01

(52) U.S. Cl. CPC G02B 27/0172; G02B 2027/013; G02B 2027/011; G02B 2027/0178; G02B 2027/0194

(57) ABSTRACT

A display device includes a first optical part that reflects at least part of incident light and a projection part that projects image light including the image information. The first optical part includes a first base, a reflective layer, a second base, and an intermediate layer. The refractive index of the first base, the refractive index of the second base, and the refractive index the intermediate layer are about the same value.

### CROSS-REFERENCE TO RELATED APPLICATION

This application is based upon and claims the benefit of priority from Japanese Patent Application No. 2014-105613, filed on May 5, 2014; the entire contents of which are incorporated herein by reference.

### FIELD

Embodiments described herein relate generally to a display device to be mounted on a head.

### BACKGROUND

A background display device projects image light toward a user by reflecting the image light on a reflector to let the user look through the display device. Such a display can be used as a HMD (Head-mounted Display). In an optical see-through HMD, an optical composition minimizing distortion of light passing through the reflector is preferably used.

### BRIEF DESCRIPTION OF THE DRAWINGS

FIG. 1 is a schematic diagram illustrating a display device according to a first embodiment.

FIG. 2 is a cross-section diagram illustrating a first optical part according to the first embodiment.

FIGS. 3A, 3B are diagrams showing manufacturing processes of the first optical part.

FIG. 4 is a diagram illustrating a hardware configuration of a processor of the display device of the first embodiment.

FIG. 5 is a cross-section diagram illustrating another example of the first optical part.

FIG. 6 is a schematic diagram illustrating the another example of the first optical part.

FIG. 7 is a cross-section diagram illustrating another example of the first optical part.

FIG. 8 is a cross-section diagram illustrating another example of the first optical part.

FIG. 9 is a schematic diagram illustrating a display device according to a second embodiment.

### DETAILED DESCRIPTION

Various embodiments will be described hereinafter with reference to the accompanying drawings. Items common to the embodiments will be given common reference symbols and will not be described redundantly.

### First Embodiment

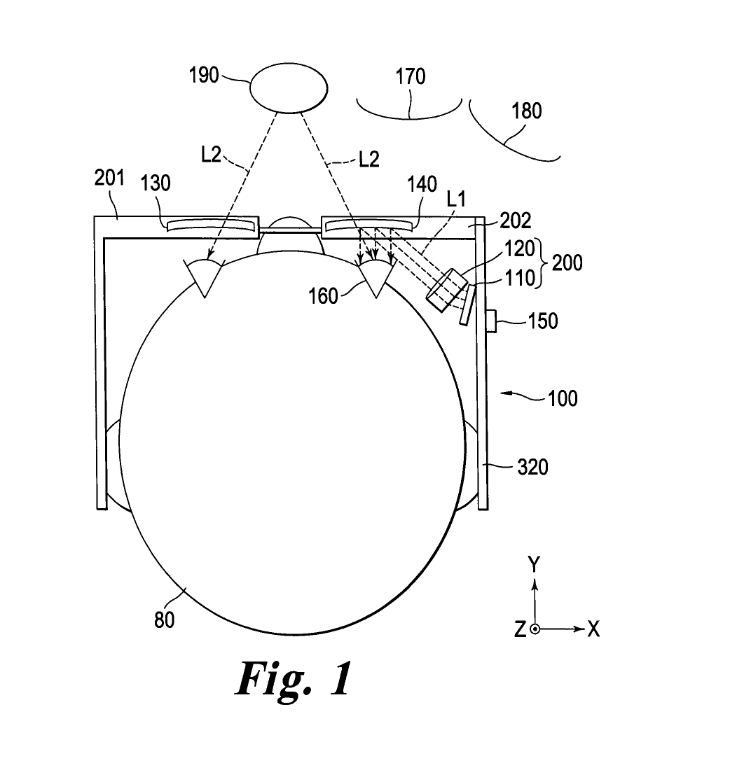

FIG. 1 is a schematic diagram illustrating a display device 100 according to the first embodiment. The display device 100 includes a projection unit 200, a first optical part 140, a second optical part 130, a processor 150, and a holding part 320. The projection unit 200 includes a display 110 and a projector 120. The projector 120 includes lenses (not shown). The holding part 320 holds the display 110, the projector 120, the first optical part 140, the second optical part 130, and the processor 150. A first frame 202 to hold the first optical part 140 and a second frame 201 to hold the second optical part 130 are formed in the holding part 320. For example, the holding part 320 is constructed of plastics or metallic material.

Positional relationships between the first optical part 140 and the projector 120, and between the projector 120 and the display 110, are fixed depending on the structure of the holding part 320. In the first embodiment, an example that the holding part 320 forms a glasses frame is described. The holding part 320 may also form goggles.

It is preferable that the projection unit 200 including the display 110 and the projector 120 is arranged between the holding part 320 and a user 80 when the user 80 wears the display device 100. Thereby, the user 80 can comfortably wear the display device 100 like ordinary glasses.

A direction connecting the first optical part 140 and the second optical part 130a is shown as the X direction. One of the directions normal to the X direction is shown as the Y direction. A direction normal to the X and Y directions is shown as the Z direction. For example, the Y direction corresponds to a front direction of the user 80. The X direction corresponds to a horizontal direction of the user 80. The Z direction corresponds to a vertical direction of the user 80.

A hardware configuration of the processor 150 is described below. The processor 150 wired or wirelessly communicates with an external device and obtains image information to be displayed on the display 110, to send to the display 110. The processor 150 wired or wirelessly communicates with the display 110. The position of the processor 150 is not limited to the position illustrated in FIG. 1.

The display 110 displays an image according to the obtained image information from the external device. The display 110 includes pixels arranged on a display surface. The display 110 emits image light L1 including the image information. The image light L1 is emitted to the projector 120. For example, the display 110 may be, but is not limited to, a liquid crystal display, an organic light emitting display, or a LCOS (Liquid Crystal On Silicon).

The projector 120 is arranged between the display 110 and the first optical part 140 on an optical path of the image light L1 emitted from the pixels of the display 110. The projector 120 includes at least one optical element. The projector 120 projects the incident image light L1. The optical element may be a lens, a prism, a mirror, and so on. The projector 120 at least partly changes a direction of the image light L1. If the projector 120 includes a plurality of the optical elements, the optical elements need not be arranged on a straight line. In FIG. 1, the display 110 is, but is not required to be, inclined relative to the projector 120.

The first optical part 140 is attached to the first frame 202. The first optical part 140 at least partly reflects the image light L1 passing through the projector 120. A detailed configuration of the first optical part 140 is described below. For example, the first optical part 140 reflects light passing through the projector 120 toward a pupil 160 of the user 80. Light reflected by the first optical part 140 and incident on the pupil 160 forms a virtual image. Accordingly, the user 80 can observe the virtual image.

In the first embodiment, an example that a virtual image 170 is displayed at a center of view of the pupil 160 is described. Alternatively, a virtual image 180 may be displayed on the edge of view of the user 80. It may be preferable to optimize a position of the virtual image so as not to disturb the view of the user 80. The position of the virtual image is controlled by adjusting the tilt of the projection unit 200. The first optical part 140 reflects at least part of the image light L1 and transmits at least part of the light L2. Accordingly, the virtual image 170 or the virtual image 180 is superimposed on to a foreground 190 being the real background. The user 80 can thereby observe a scene that includes the optically-superimposed virtual image.

FIG. 1 shows an example of a monocular HMD that displays the virtual image by using a single display device 100. In FIG. 1 the display device 100 and the first optical part 140 are arranged on the right-eye side. Alternatively, the display device 100 and the first optical part 140 could be arranged on the left-eye side.

As shown in FIG. 1, the second optical part 130 pairing up with the first optical part 140 is mounted on the second frame 201. The second optical part 130 transmits at least part of the light L2 from the foreground 190. The optical transmissibility of the second optical part 130 may be various values as long as the second optical part 130 transmits at least part of light L2 from the foreground 190. If the second optical part 130 is more transparent than the first optical part 140, restriction of vision is reduced. If the optical transmissibility of the second optical part 130 is nearly equal to that of the first optical part 140, the vision in the right eye and the left eye are uniform.

An optical reflectivity, an optical absorptance, and an optical transmissibility may be respectively a spectral reflectivity, a spectral absorption index, and a spectral transmittance. The optical reflectivity, the optical absorptance, and the optical transmissibility satisfy equation (1) below.

(the optical reflectivity(+(the optical absorptance(+(the optical transmissibility)=1 equation (1)

For example, an optical reflectivity is determined by measuring a ratio of reflected light to incidence light, e.g., by an intensity of the reflected light on an integrating sphere of a spectral photometer. Also, the optical transmissibility can be determined by measuring a ratio of transmitted light to the incident light on the integrating sphere of the spectral photometer. The optical absorptance can be calculated by substituting the transmissibility and the reflectivity measured according to the methods described above in the equation (1).

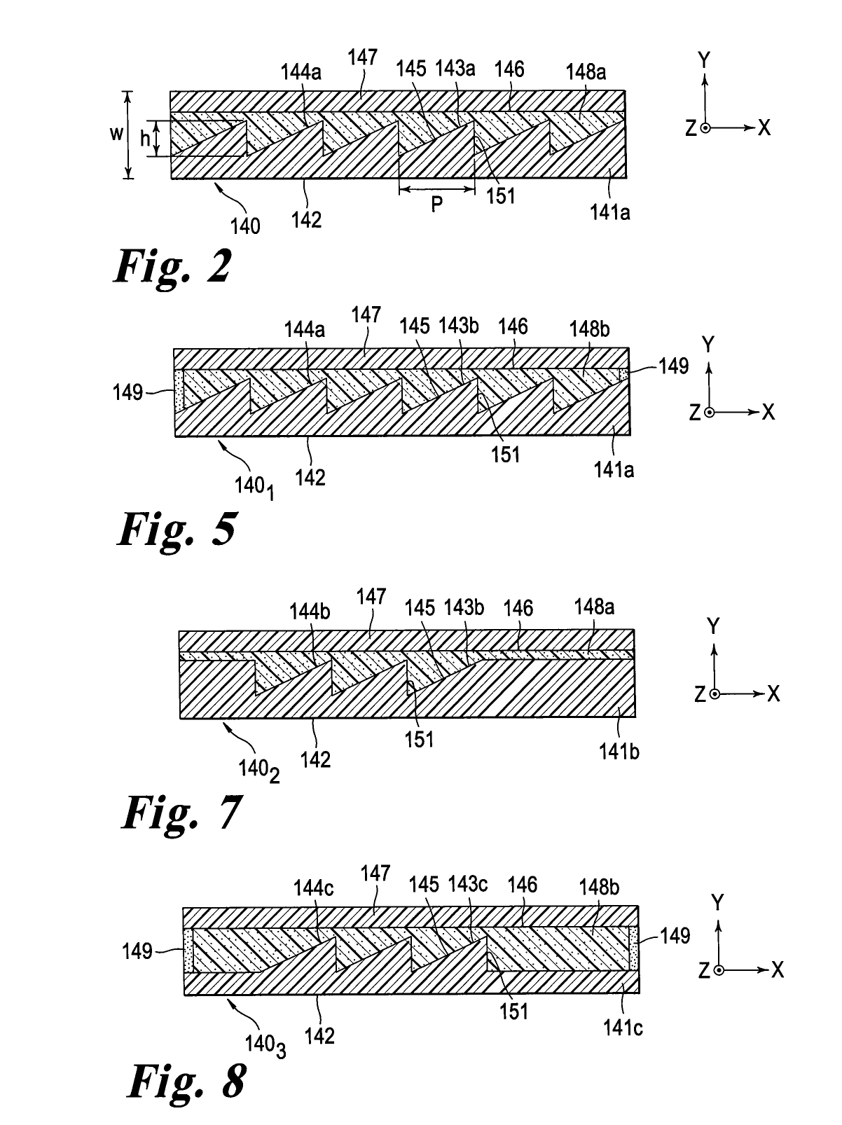

FIG. 2 illustrates the first optical part 140 of the first embodiment. The first optical part 140 includes a first base 141a [?] that is transparent, a reflective layer 145 formed on the first base 141a and at least partly reflecting the image light L1, a second base 147 that is transparent, and an intermediate layer 148a. The first base 141a includes a ridged surface 144a [?] on which a plurality of the inclines 143a [?] and steps 151 are formed. The incline 143a is inclined with respect to a surface 142 of the first base 141. The surface 142 may be a curved surface. An angle of the incline 143a is determined by a positional relationship between an optical axis of the light transmitted by the projector 120 and a view point. Although an example that the incline 143a is flat is illustrated in FIG. 2, the incline 143a may be a refractive curved surface having power.

The step 151 is a surface for maintaining the first optical part 140 within a specific thickness. The reflective layer 145 is formed on at least part of the incline 143, and reflects part of the light incident on the reflective layer 145.

An optical reflectivity of the reflective layer 145 is greater than that of the first base 141a. The reflective layer 145 reflects the light transmitted by the projection unit 200. In this embodiment, an example that the reflective layer 145 is formed on the whole surface of the ridged surface 144 in the first optical part 140 (including the incline 143 and the step 151) is described.

The reflective layer 145 may not be formed on the step 151. The step 151 maintains the first base 141 within a specific thickness. The reflective layer 145 on the incline 143a is at a specific degree angle to the light transmitted by the projector 120. If the light transmitted by the projector 120 is reflected on the step 151, it may cause unevenness of the virtual image. Accordingly if the reflective layer 145 is not formed on the step 151, unevenness of the virtual image can be reduced. To form selectively the reflective layer 145, mask processing and laser removal processing may be used.

The second base 147 includes an opposing surface 146 opposing the ridged surface 144a. The opposing surface 146 has a surface shape such that the first base 141a and the second base 147 are separated by a gap when the opposing surface 146 is arranged opposing the ridged surface 144a. The opposing surface 146 is shaped so that the first base 141 and the second base 147 are separated by a gap when the opposing surface 146 is arranged opposite to the ridged surface 144a.

The opposing surface 146 is a flatter surface than the ridged surface 144. The opposing surface 146 is a curved surface as a whole. The opposing surface 146 may be an irregular surface. In that case, a difference in height of the opposing surface 146 is less than a height of the ridged surface 144a. The opposing surface 146 may be flat.

An intermediate layer 148a is put between the ridged surface 144a and the opposing surface 146, and is bonded to ridged surface 144a and the opposing surface 146.

The thickness (W) of the first optical part 140 is approximately 1˜3 [mm]. A pitch (P) of the incline 143 in the X direction is about a few hundred [μm]. An angle between the surface 142 and the incline 143 is approximately 10°˜20°. The values described above may be different values.

A material such as a transparent plastic (for example, acrylic, carbonate system, urethane, or epoxy system material) may be used as the first base 141a and the second base 147. The second base 147 may be glass. Optimally, a refractive index of the second base 147 is about the same as the refractive index of the first base 141a.

As the intermediate layer 148a, acrylic, epoxy, or polyurethane optical adhesive may be used.

An absolute difference between the refractive index of the intermediate layer 148 and the refractive index of the first base 141a is less than 1% of the refractive index of the first base 141a (more preferably less than 0.1%). The refractive index indicates a substance-specific refractive index relative to vacuum. An absolute difference between the refractive index of the intermediate layer 148 and a refractive index of the second base 147 is less than 1% of the refractive index of the second base 147 (more preferably less than 0.1%). It is preferable that the first base 141a and the second base 147 are made of the same material.

It is preferable that the first optical part 140 is held by the first frame 202 so that the surface 142 of the first base 141a faces the user 80. If the first base 141a and the second base 147 are arranged so that the surface 142 faces the foreground 190, before and after the light emitted by the projection unit 200 is reflected on the reflective layer 145, the light passes through interface between the intermediate layer 148a and the second base 147 twice. Due to a restriction of materials, it may be difficult to implement the refractive indexes of the intermediate layer 148a and the second base 147 to be exactly the same. So incident light is slightly refracted at the interface between the intermediate layer 148a and the second base 147. That may cause a double image or distortion of the virtual image 170 or 180. If the surface 142 is arranged on the user 80 side, the user 80 can observe better quality of the virtual image 170 or 180. The surface 142 of the first base 141 may be arranged on the foreground 190 side. As well, the user 80 can observe the virtual image 170 or 180.

It is preferable that an angle between the step 151 and either the surface 142 or the opposing surface 146 is approximately 90°. Specifically, it is preferable that the angle is 90°±3°. The difference between the refractive index of the intermediate layer 148 and a refractive index of the first base 141a should be sufficiently small. Practically configuring the refractive index of the intermediate layer 148 and the first base 141a to be exactly the same may be difficult. If an angle of the step 151 is approximately a right angle, the light L2 from the foreground 190 passing through the step 151 is reduced. Thereby, an effect of the user seeing a double image is reduced.

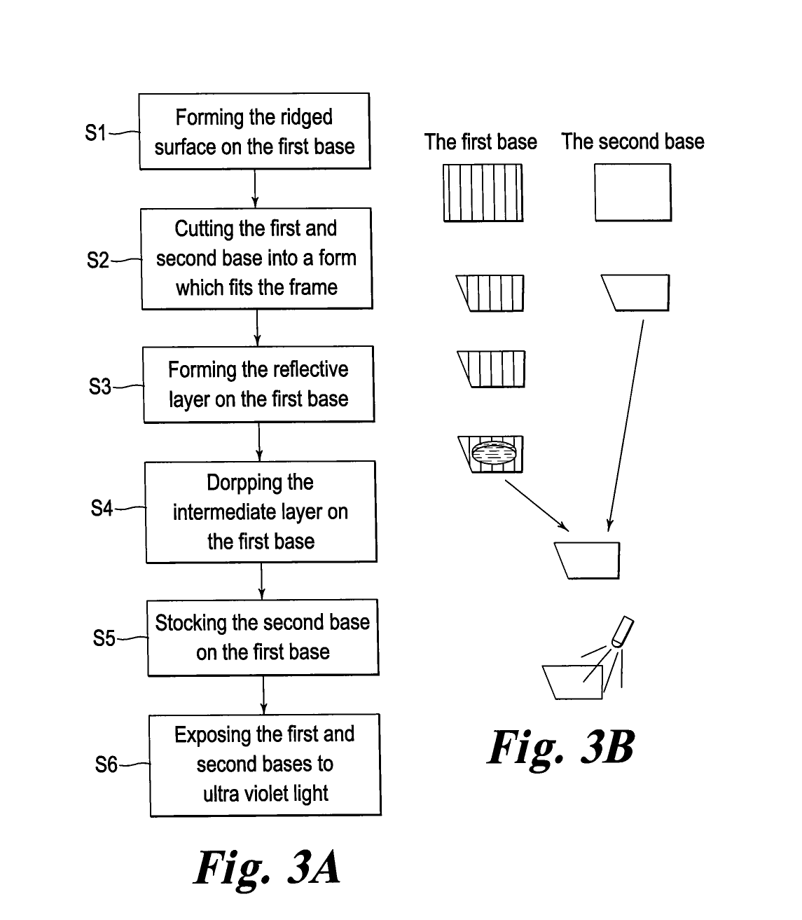

FIGS. 3A, 3B show manufacturing processes of the first optical part 140 illustrated in FIG. 2.

The irregular ridged surface 144a is formed on the first base 141a (S1). In the case that the first base 141a is made from thermoplastic resin, for example, injection molding is used. The thermoplastic resin is heated to a softening temperature, and is poured into a mold applying injection pressure. By using a mold with a concavo-convex shape formed on its surface, the ridged surface 144a can be formed on the first base 141a. Press working may be used to form the ridged surface 144a on the first base 141a.

Next, the first base 141a of the ridged surface 144a is cut in the shape of the first frame 202. The second base 147 is cut in the shape of the second frame 201 (S2).

The reflective layer 145 is then formed on the ridged surface 144a of the first base 141a (S3). For example, plating, evaporation coating, or spattering is used to form the reflective layer 145. A ratio of reflected light and transmitted light can be varied depending on a thickness of the reflective layer 145. The ratio of the transmitted light increases as the reflective layer 145 becomes thinner. The ratio of the reflected light increases as the reflective layer 145 becomes thicker. The reflective layer 145 may be formed on part of the ridged surface 144a.

The intermediate layer 148 in the form of a liquid is then dropped on a side of the ridged surface 144a (S4). In this embodiment, an example that the intermediate layer 148 is made by synthetic resin which chemically changes from a liquid to a solid in response to ultraviolet energy is described.

The second base 147 is then stacked on the first base 141 so that the intermediate layer 148 is held between the first base 141 and the second base 147 (S5).

The first base 141a, the second base 147, and the intermediate layer 148a are then exposed to ultraviolet light to cure the intermediate layer 148a (S6). The first optical part 140 is manufactured according to the processes described above.

The manufacturing processed described above is one example, and the order of steps may be changed. Also, other methods may be used as substitutes of each step.

In a comparative example that the opposing surface of the second base is formed into a ridged shape so that the opposing surface fits the ridged surface of the first base, and is stacked on the first base, the ridged surfaces between the first base and the second base have to fit precisely. Accordingly the comparative example is more difficult to manufacture.

In this embodiment, the opposing surface 146 and the ridged surface 144a need not necessarily fit precisely, which provides simpler manufacture processes than the comparative example.

The intermediate layer 148a is filled in a gap between the opposing surface 146 and the ridged surface 144a. In the case of the first optical part 140 shown in FIG. 2, the light L2 from the foreground 190 passes through the interfaces between the first base 141a and the intermediate layer 148a and between the intermediate layer 148a and the second base 147 before entering the pupil 160. The ridged surface 144a and the opposing surface 146 are not parallel to each other, so a distance of the optical pass in the intermediate layer 148a and the first base 141a may vary. If refractive indexes of the intermediate layer 148a, the first base 141a, and the second base 147 are not the same, light may refract at the interface between the intermediate layer 148a and the first base 141a, and the interface between the intermediate layer 148a and the second base 147, which may cause distortion of the foreground or a double image.

If the intermediate layer 148a is made of a material with a refractive index similar to that of the first base 141a and the second base 147, distortion of the foreground is minimized.

According to this embodiment, reflection of the light at the interface between the first base 141a and the intermediate layer 148a and at the interface between the intermediate layer 148 and the second base 147 is suppressed. Accordingly, the user 80 can observe an image in which distortion is minimized.

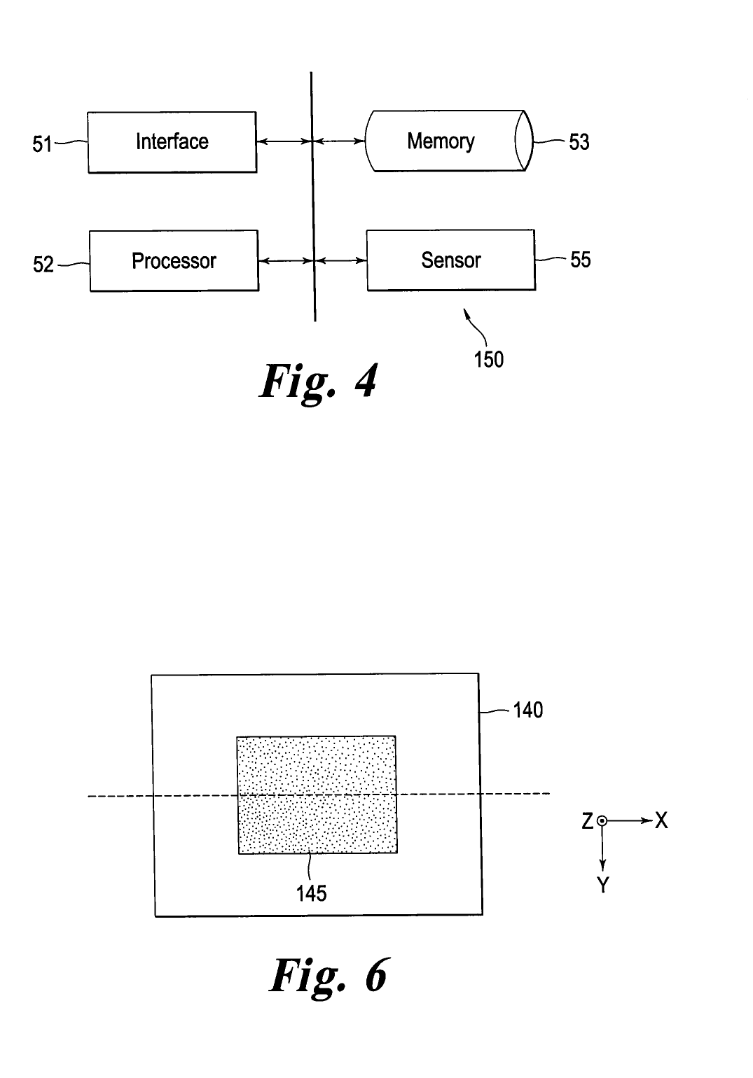

FIG. 4 shows a hardware configuration of the processor 150 according to each of the embodiments.

As shown in FIG. 4, the processor 150 includes an interface 51, a processor 52, a memory 53, and a sensor 55.

The interface 51 is wired or wirelessly connected to an external memory device, or a network. The interface 51 obtains the image information. The interface 51 may communicate information other than the image information. The interface 51 wired or wirelessly communicates with the display 110, and sends the image information to be displayed to the display 110.

The memory 53 stores various data including, but not limited to, a program that processes the image information obtained from the external device. For example, a program that transforms the image information so that the image is appropriately displayed on the display 110 is stored in the memory 53. Also, the memory 53 may store the image information. The program may be installed in the memory 53 in advance, or be installed in the memory 53 via a storage media such as CD-ROM or a network.

Any kind of sensors (for example, a camera, a microphone, a position sensor, or an acceleration sensor) may be used as the sensor 55. The processor 52 may control the image displayed on the display 110 based on information obtained from the sensor 55, which enables to increase usability and visibility of the display device 100.

Functions of the processor 150 according to each embodiment may be partly or wholly implemented by a general semiconductor integrated circuit such as a LSI (Large Scale Integration) or an IC (Integrated Circuit) tip set, or a customizable electronic circuit such as an FPGA (field programmable gate array).

(A Modification 1)

FIG. 5 is a schematic diagram illustrating an example of modified first optical part 1401. The first optical part 1401 in this modification includes a bonding part 149. Also, a different intermediate layer 148b as a liquid than in the first optical part 140 in FIG. 2 is utilized. The bonding part 149 bonds outer circumferential edges of the first base 141a and outer circumferential edges of the second base 147, and seals the intermediate layer 148b between the first base 141a and the second base 147.

The intermediate layer 148b, for example, may be paraffinic oil, and a mixture of polybutene. The bonding part 149, for example, may be epoxy resin, and acrylate resin. If the bonding part 149 is pasted on outer circumferential, the bonding part 149 has little influence on visuals. Accordingly, the bonding part 149 may be non-transparent.

The first optical part 1401 shown in FIG. 5 may be manufactured using a same method as generally used to inject liquid crystal between substrates of a liquid crystal panel. The bonding part 149 serving as adhesive is pasted on the outer circumferential edges. Next, the bonding part 149 is pierced. Maintaining a vacuum, the liquid intermediate layer 148b is then injected into the gap between the first base 141a and the second base 147.

It is preferable that a refractive index of the intermediate layer 148b is substantially the same as refractive indices the first base 141a and the second base 147. If an absolute difference of refractive indexes between either the first base 141a or the second base 147 and the intermediate layer 148b is less than 1% of a refractive index of either the first base 141a or the second base 147, visual influence on the user 80 is within an acceptable range. The intermediate layer 148a in FIG. 2 needs to be adhesive with the first base 141a and the second base 147. In contrast, a material of the intermediate layer 148b in FIG. 5 is not restricted to an adhesive material. Due to less restriction, the intermediate layer 148b may be made by a material having a more similar refractive index to that of the first base 141a and the second base 147. An absolute difference of the refractive index between either the first base 141a or the second base 147 and the intermediate layer 148b may be about 0.1%˜0.01% of the refractive index either the first base 141a or the second base 147.

(A Modification 2)

FIG. 6 illustrates another variation of the first optical part 140. In FIG. 6, the reflective layer 145 is only partly formed on the incline 143 and on the step 151. The area where the light from the projector 120 reaches may thereby be confined to only part of the first optical part 140. If the reflective layer 145 is not formed on such an area, the user 80 may be able to observe the foreground 190 more clearly.

FIG. 7 illustrates a cross-section of another example of a first optical part 1402. A plane surface 152 is formed on part of the ridged surface 144b. In FIG. 7 the reflective layer 145 is not formed on the plane surface 152. If the area not covered with the reflective layer 145 is formed flat, unwanted stray light can be reduced. The intermediate layer 148a is made of a similar material of the intermediate layer 148a described in FIG. 2. The plane surface 152 is at a lesser angle to the surface 142 than the incline 143. Or the plane surface 152 is parallel to the surface 142.

FIG. 8 illustrates a cross-section of another example of a first optical part 140₃. The intermediate layer 148b is a liquid, same as the intermediate layer 148b in FIG. 5. The bonding part 149 bonds the first base 141c and the second base layer 147, and seals the intermediate layer 148b. A thickness between the surface 142 and the plane surface 152 in FIG. 7 and FIG. 8 may be any thickness.

As another example, the reflective layer 145 may be formed on the plane surface 152 illustrated in FIG. 7 and FIG. 8. The first optical part 140 and the second optical part 130 transparent evenly. The user 80 feels a less feeling of strangeness. Also it is easy to manufacture.

An another modification, in any of the embodiments, the ridged surface 144a, 144b, 144c may be formed on the whole surface of the first base 141, and the reflective layer 145 may be formed on part of the ridged surface 144a, 144b, 144c (not shown in the figure).

### A Second Embodiment

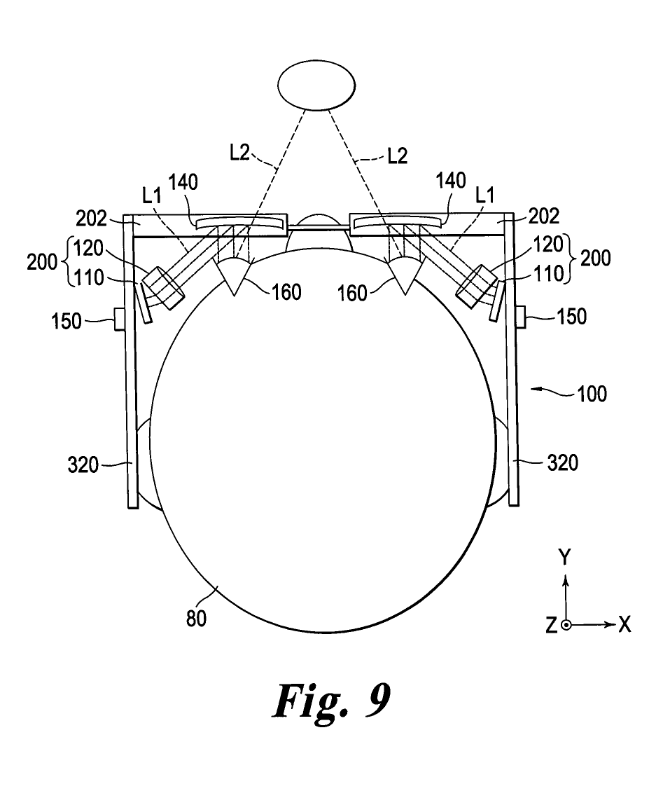

FIG. 9 illustrates a display device 400 of a second embodiment.

The display device 400 is different in the numbers of the projection units and the first optical parts from the display device 100 according to the first embodiment of FIG. 1. The first optical parts 140 and the projection units 200 are arranged for both eyes. The incline 143 of the first optical part 140 for a right eye is line-symmetric to the incline 143 of the first optical part 140 for a left eye. An axis of the line-symmetric is the Y-axis. In FIG. 9, the processors 150 are respectively disposed on right and left sides. The display device 400 may also have only a single processor 150.

The drawings described above are schematic or conceptual; and the relationships between the thicknesses and the widths of portions, the proportional coefficients of sizes between portions, etc., are not necessarily the same as the actual values thereof. Further, the dimensions and/or the proportional coefficients may be illustrated differently between the drawings, even for identical portions.

Terms “normal” and “parallel” in each of the embodiments include manufacturing errors.

While certain embodiments have been described, these embodiments have been presented by way of example only, and are not intended to limit the scope of the inventions. Indeed, the novel embodiment described herein may be embodied in a variety of other forms; furthermore, various omissions, substitutions and changes in the form of the embodiment described herein may be made without departing from the spirit of the inventions. The accompanying claims and their equivalents are intended to cover such forms or modifications as would fall within the scope and spirit of the inventions.

What is claimed is:

1. A head-mounted display device comprising:
a first optical part that reflects at least part of incident light, and includes:
a first base that includes a ridged surface on a first surface on which inclines are formed;
a reflective layer formed on at least part of the inclines and that reflects at least part of the incident light;
a second base opposing the first surface, and including a second surface that is less irregular than the first surface; and
an intermediate layer between the first surface of the first base and the second surface of the second base; and
a projection part that projects image light including the image information;
wherein a refractive index of the first base, a refractive index of the second base, and a refractive index the intermediate layer are substantially a same value.

2. The device according to claim 1, wherein the second surface on the second base is flat.

3. The device according to claim 1, wherein a difference in height of the second surface is less than a height of the incline on the ridged surface.

4. The device according to claim 1, wherein the second surface is shaped so that the first and the second base are separated by a gap.

5. The device according to claim 1, wherein an absolute difference in refractive index between the intermediate layer and the first base is less than 1% of the refractive index of the first base.

6. The device according to claim 1, wherein an absolute difference in refractive index between the intermediate layer and the first base is less than 0.1% of the refractive index of the first base.

7. The device according to claim 1, wherein an absolute difference in refractive index between the intermediate layer and the second base is less than 1% of the refractive index of the second base.

8. The device according to claim 1, wherein an absolute difference in refractive index between the intermediate layer and the second base is less than 0.1% of a refractive index of the second base.

9. The device according to claim 1, wherein the refractive index of the first base is substantially a same as that of the second base.

10. The device according to claim 1, further comprises a bonding part that bonds the first base and the second base, wherein the intermediate layer is liquid, and the bonding part seals the intermediate layer.

11. The device according to claim 1, wherein the first base is made of a same material as the second base.

12. The device according to claim 1, wherein the first base includes a planar surface on part of the first surface which is at less angle to the first base than the incline than.

13. The device according to claim 12, wherein the reflective layer is not formed on the planar surface.

14. The device according to claim 1, wherein the first base includes steps extending in a direction of the incline on the first surface, wherein the steps are normal to the first base.

15. The device according to claim 1, wherein the projection part includes a display and projector.

16. The device according to claim 1, wherein the intermediate layer is made by a material cured under ultra violet light.

17. The device according to claim 1, further comprising a holder that holds the first optical part and the projector.
